(19) United States
(12) Patent Application Publication
(10) Pub. No.: US 2021/0269288 A1
(43) Pub. Date: Sep. 2, 2021

(54) SERVICE UNIT APPARATUS FOR SERVICE VEHICLES

(71) Applicant: Heritage Industries, LLC, Salt Lake City, UT (US)

(72) Inventor: Marshall Hatch, Bountiful, UT (US)

(21) Appl. No.: 16/805,439

(22) Filed: Feb. 28, 2020

(51) Int. Cl. B66C 23/40; B66C 23/44

(52) U.S. Cl. CPC B66C 23/40; B66C 23/44

(57) ABSTRACT

A service unit apparatus, which is suited to support one or more service equipment devices such as a fuel-powered engine, an electric motor, an electric power generator, a hydraulic pump, a crane, an air compressor, tanks to hold compressed air, batteries, a battery charger, a power unit and/or a reservoir of hydraulic fluid. The service unit may be configured to attach to a service vehicle rearward of the cab of the service vehicle. The service unit may be constructed to include one or more outriggers.

### BACKGROUND OF THE INVENTION

### 1. Field of the Invention

There are a number of configurations of equipment for providing lifting, power, maintenance and repair support for heavy objects, vehicles and other equipment. Such equipment has been placed on a service vehicle for mobile transport.

### 2. Background and Related Art

A wide variety of mobile service vehicles have been constructed to support service needs of commercial, industrial, mining, agricultural, municipal, construction, pumping, railroad and other industries. Service vehicles can include various service equipment such as cabinetry, machines, product tanks and/or cranes. Known service vehicles arrange equipment in various configurations about the service vehicle such that a substantial portion of the area of the structural frame and/or service bed rear of the cab of the service vehicle is occupied by service equipment.

### SUMMARY OF THE INVENTION

The disclosed technology presented in this patent relates generally to a service unit apparatus configured to minimize the area and location of service equipment devices disposed behind the cab of the service vehicle in more efficient and desirable ways to better meet the service needs and requirements of the service vehicle while allowing the remaining portion of the area behind the cab of the service vehicle to be available for other uses or equipment.

The disclosed technology relates to an apparatus which is scalable, portable, compact, multi-function/machine service unit for providing power, maintenance and repair support for vehicles and equipment. In particular, the service unit is disposed on the structural frame or service bed of a service vehicle for mobile transport of the service unit. The service unit may be confined to a narrow corridor laterally across the service vehicle rearward of the cab of the service vehicle.

For purposes of this patent when the term “service unit” is used it refers to an apparatus in the nature of a support framework on which service equipment devices may be arranged and positioned. The service unit is independent of structure of the service vehicle. The service unit may be installed onto the service vehicle.

In particular, the service unit apparatus or assembly is arranged and installed on the structural frame or service bed of the service vehicle such that it occupies a limited, lateral area or corridor rearward of the cab of the service vehicle. In one embodiment the service unit apparatus occupies a substantially rectangular footprint and is positioned adjacent the rear of the cab of the service vehicle and forward of the service bed or other service equipment positioned on the structural frame of the service vehicle.

The service unit apparatus may comprise a plurality of or one or more service equipment devices such as self-contained electrical or engine-generated power supplies with an electrical power unit to alter or store electrical power, a welder, an air compressor with tanks for compressed air, a hydraulic pump with a supply of hydraulic fluid, an electric motor, a crane, stabilizing outriggers, auxiliary power outlets for other service equipment and tools and/or desirable cabinetry.

These and other features and advantages of the disclosed technology will be set forth or will become more fully apparent in the description that follows and in the appended claims. The features and advantages may be realized and obtained by employing the disclosure of this patent and as particularly pointed out in the appended claims and their equivalents. Furthermore, the features and advantages of the disclosed technology may be learned by the practice of it or may be derived from the description set forth hereinafter without undue experimentation.

### BRIEF DESCRIPTION OF THE DRAWINGS

In order that the manner in which the above referenced and other features and advantages of the disclosed technology are achieved, a more particular description of the invention will be rendered through reference to exemplary embodiments illustrated in the appended drawings. It will be appreciated by one of skill in the art that the following descriptions and drawings depict only exemplary embodiments of the disclosed technology and are not, therefore, to be considered as limiting in scope. Therefore, the disclosed technology is described and explained with additional specificity and detail through the use of the accompanying drawings in which:

FIG. 1 is a perspective and break-away view of a service vehicle bearing one embodiment of the service unit apparatus positioned on a service vehicle in accordance with the disclosed technology;

FIG. 2 is a view of a perspective view of one embodiment of the service unit in accordance with a representative embodiment of the disclosed technology;

FIG. 3 is another view of the embodiment of the service unit of FIG. 2; and

FIG. 4 is a view of an under portion of the service unit with integrated compressed air tanks in accordance with a representative embodiment of the disclosed technology.

### DETAILED DESCRIPTION OF THE INVENTION

The disclosed technology relates generally to mobile service units, and more specifically, to an assembly of service equipment devices arranged to minimize the volume of space the devices occupy in relation to the service area behind the cab of a service vehicle transporting the service equipment devices.

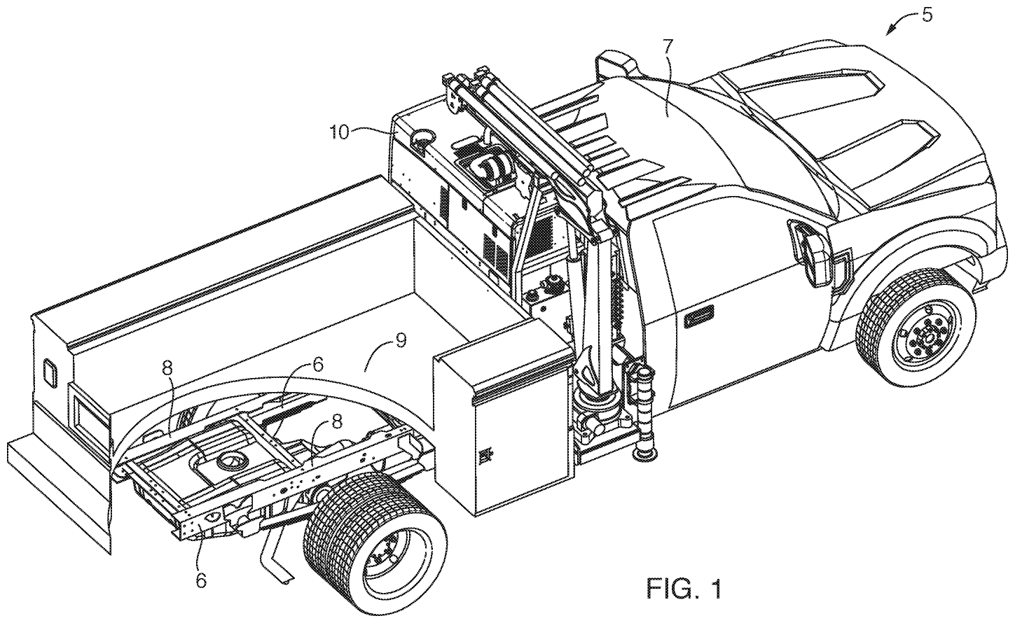

As shown generally in FIG. 1, a service vehicle 5 is depicted. Service vehicle 5 has a service bed 9 rearward of the cab 7 of service vehicle 5. Service bed 9 comprising an upper surface and a lower surface. The lower surface of service bed 9 may be supported by, attached to or adjacent the structural frame 6 of the service vehicle. Structural frame 6 comprises a top or support side 8. In one embodiment, service bed 9 and/or service unit 10 may be disposed on support 8 of frame 6.

Cab 7 and service bed 9 having respect lengths and widths; the length being in the direction of travel of the service vehicle and the width being substantially normal to the length. As shown in FIG. 1, the desired service equipment devices of a service unit apparatus 10 may by clustered rearward of cab 7 and forward of service bed 9. In this way, service bed 9 is left substantially unoccupied and available for other service needs such as cabinetry, products, supplies, tools, etc.

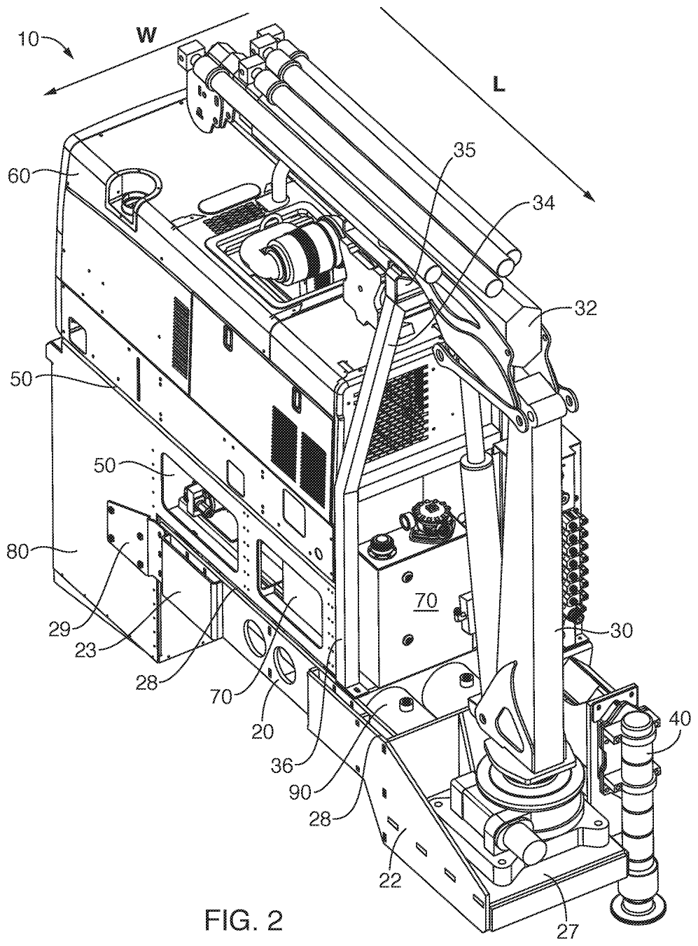

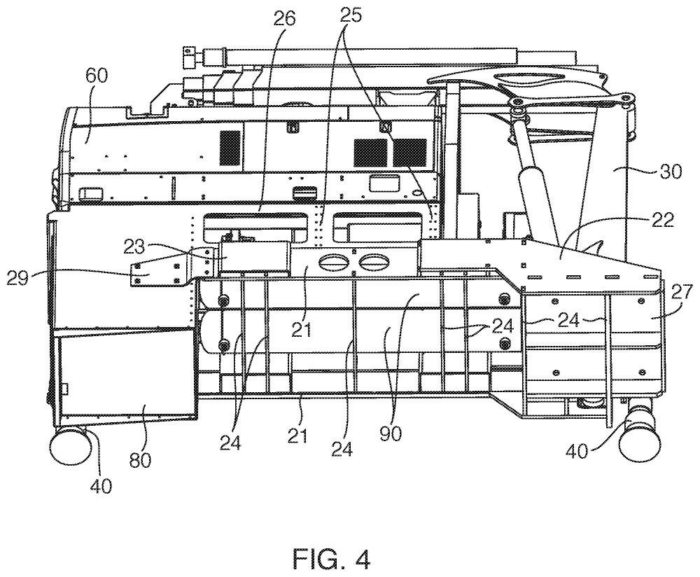

As shown in FIG. 2, service unit 10 may comprise a plurality of components. By way of example, service unit 10 may comprise a support framework 20, a crane 30, outriggers 40, equipment location 50, a housing 60 to contain other service equipment devices, containers 70, an enclosure 80, and/or tank(s) 90 (see also FIG. 4) to store compressed air within framework 20.

For purposes of describing the dimensions of service unit 10, service unit 10 defines a length and a width; the length of service unit 10 is its longer lateral dimension L and the width or depth of service unit 10 is its shorter lateral dimension W when seen in a top or plan view.

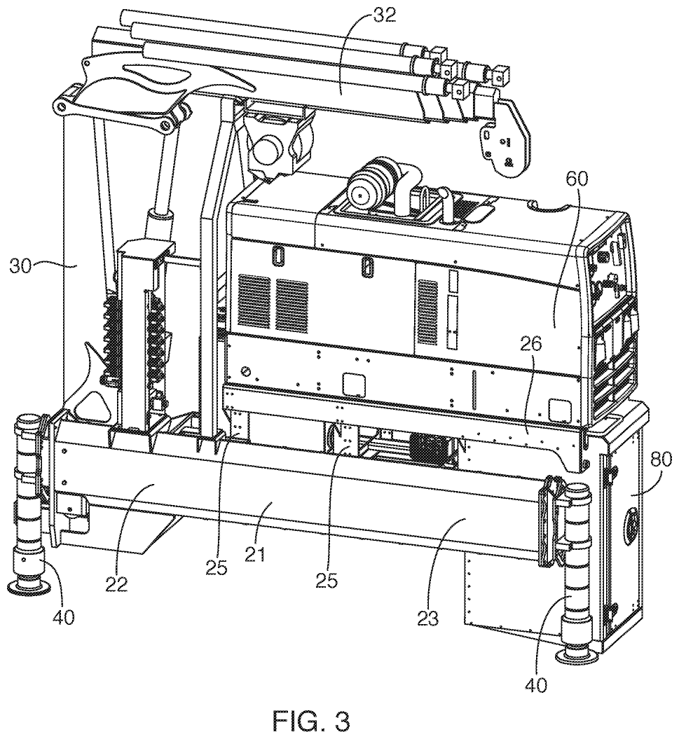

As shown in FIGS. 2-4, framework 20 is separate from the structural components of the service vehicle. Framework 20 comprises one or more lateral beams or support member 21. Support members 21 provide a top support surface 28 and define a first end 22 and a second end 23 of framework 20. Support member 21 extends along the length of service unit 10. The vertical dimension or height of support member 21 is a factor of desired design choice, weight and/or support strength requirement. When more than one support member 21 is used, support members 21 may be secured in relative position to each other by cross members 24 or other compatible blocking.

Framework 20 may further comprise one more vertical support members 25 and one or more supplement lateral support members 26. As shown in FIG. 2-4, members 25 and 26 can be configured to create spaces, platforms or a support surface to provide equipment location positions 50 for the placement of service equipment devices or for housing 60. Framework 20 is configured to be anchored to the structural frame 6 of the service vehicle rearward of cab 7. Support member 21, 24, 25 and 26 may be constructed of aluminum, steel, or other metal or composite materials, or a combination of aluminum, steel, other metal and/or composite materials depending on the desired weight of service unit 10 and/or on the structure support required by the service equipment devices being supported by members 21, 24, 25 and 26, as disclosed below.

Support framework 20 may further comprise a mounting deck or platform 27 at or near either the first end 22 or second end 23 of framework 20. Mounting deck 27 comprises a step-down support surface. Mounting deck 27 may be configured to be about four to twenty-four inches lower than top surface 28 of member 21. That is, mounting deck 27 may be positioned vertically lower than top support surface 28 of member 21. Further, when service unit 10 is installed on the service vehicle mounting deck 27 is lower than the upper surface of service bed 9 and/or the top surface of service vehicle frame 6.

As a result, top surface 28 of member 21 may provide a first support surface, mount deck 27 may provide a second support surface and member 26 may provide a third support surface. It is contemplated that one or more service equipment devices may be positioned on the first and/or third support surfaces.

Support framework 20 may be further adapted at either first end 22 or second end 23 of support member 21 to provide a support frame interface 29 to which enclosure 80 may be attached. Enclosure 80 may be attached to frame interface 29 in any suitable manner such using fasteners, riveting, welding and the like. In one embodiment, as shown in FIG. 1, enclosure 80 is attached to frame interface 29. Support frame interface 29 and enclosure 80 may be constructed of aluminum, steel, or other metal or composite materials, or a combination of aluminum, steel, other metal and/or composite materials depending on the desired weight of interface 29 and enclosure 80. As a result, the construction materials of interface 29, enclosure 80 and/or support member 21 may be the same or different from each other.

As shown in the Figures, support member 21 may be further adapted to facilitate attachment of one or more outriggers 40 to support framework 20 at or near first end 22 and/or at or near second end 23 of framework support 20.

Crane 30 may comprise any suitable known crane compatible with the other features of the disclosed technology. Examples of suitable cranes include the FASSI M40A. Crane 30 may be attached to support framework 20 on the step-down support surface of mounting deck 27. This vertically lower placement of crane 30 on mounting deck 27 provides an ergonomic advantage for the crane operator by lowering crane 30 and its controls closer to the operator on the ground next to the service vehicle. This lower vertical placement of mounting deck 27 also provides the advantage of lowering the overall storage and/or transportation height of crane 30 on the service vehicle providing improved aesthetics and improved driving clearance height by lowering the service vehicle's clearance ratings. If crane 30 is hydraulically driven, a hydraulic pump for the operation of crane 30 may be mounted on framework 20. For example, locations 50 on framework 20 defined by support members 25 or 26 may be suitable for placement of a hydraulic pump or system. In the alternative, a hydraulic pump or hydraulic system may be placed in housing 60.

Preferably, the nature of crane 30 and the length of crane boom 32 are selected or configured to maintain crane 30 and crane boom 32 within the footprint of service unit 10 when crane 30 is not in use and during travel of the service vehicle.

The positioning of crane 30 during non-use and during transport may be facilitated by a crane boom support 34. Boom support 34 may be configured with a cradling or nesting brace 35 to receive crane boom 32 in a repose position. In one embodiment boom support 34 may comprise one or more support limbs 36 extending from brace 35. Support limbs 36 may be attached to framework support 20. In other embodiments (not shown), brace 35 and/or support limbs 36 may be attached to a side or top of housing 60 or to the top or back of the cab of the service vehicle. In a preferred embodiment, the height of the cradled crane boom is substantially coextensive to the height of the cab of the service vehicle. Boom support 34 may be constructed of aluminum, steel, or other metal or composite materials, or a combination of aluminum, steel, other metal and/or composite materials depending on the desired weight and support requirements of boom support 34.

One or more outriggers 40 may be attached to support framework 20. Outrigger 40 is typically telescoping in nature in the vertical direction and driven by hand-crank, electrical power or hydraulic systems which can all be hosted on support framework 20 or within housing 60. In one embodiment, support member 21 has a length sufficient to permit one or more outriggers 40 to be fixedly joined at or near first end 22 and/or at or near second end 23 of framework support 20 by a bolt-on assembly, welding and the like. In other embodiments, not shown, outrigger 40 may also comprise telescoping or sliding lateral extenders permitting one or more outriggers 40 to be extended or drawn laterally a distance away from service unit 10 as needed or desired. Outrigger 40 provides leveling and stabilizing functions for the service vehicle. During operation of crane 30, one or more outriggers 40 extended to the ground act to distribute the crane's load over a larger area and to distribute the moment force resulting from the placing and loading of crane 30 on mounting deck 27 across outriggers 40.

One or more equipment locations 50 may be defined by support framework 20. Location 50 may provide a platform to which one or more service equipment devices may be secured such as electrical motors or gas or diesel engines to generate electric power, to power hydraulic systems or to power air compressors, hydraulic pumps and the like.

Housing 60 encloses one or more desired service equipment devices. Housing 60 is supported by support framework 20 as shown in the Figures. Depending on the nature and needs of the service vehicle, housing 60 may comprise a top and side doors or panels. One or more side doors or panels may comprise a hinged or sliding connection such that a door or panel may be opened for access, servicing, repair and the like. Top and/or side doors/panels provide a protective and/or insulative enclosure for service equipment devices contained therein to guard against adverse contact, temperature, moisture, weather, dust, dirt and other environmental elements which may have a detrimental effect on service equipment devices. Housing 60 may also comprise electrical power receptacles for receiving electrical power from an external power source or for providing electrical power to electrically driven service equipment devices and power tools. Examples of service equipment devices that may be enclosed in housing 60 include a welder, an air compressor, components of a hydraulic system, an electrical power unit including converters, batteries, chargers, and/or other suitably sized service equipment devices or appliances.

Containers 70 may serve a number of functions. For example, when service unit 10 comprises a hydraulic system, all or a portion of one or more containers 70 may hold a reservoir of hydraulic fluid. In the alternative, when service unit 10 comprises an electrical power unit and/or electrical power equipment, all or a portion of one or more containers 70 may hold batteries. Still further, when service unit 10 comprises both a hydraulic system and electrical service equipment devices, the available space in containers 70 can be allocated to accommodate hydraulic and electrical service needs and requirements. In one embodiment, instead of have multiple containers 70, a single L-shaped container 70 may be used as desired.

As exemplified in FIG. 2, enclosure 80 may be attached to frame interface 29 such that the base of enclosure 80 is vertically lower than the base of framework 20 supported by frame 6 of the service vehicle, the top of service bed 9 and/or top side 8 of frame 6 of the service vehicle. This vertically lower placement of enclosure 80 provides an ergonomic advantage for the service operator by lowering enclosure 80 closer to the operator on the ground next to the service vehicle. It is contemplated that enclosure 80 may be used for any purpose for the convenience of the service operator or for the storage and retrieval of supplies, other equipment or tools or personal items. In another embodiment support members 25 and 26, interface 29 and enclosure 80 are one integral construction of the same construction material. Housing 60, containers 70 and enclosure 80 may be constructed of plastic, sheet metal, aluminum, steel, or other metal or composite materials, or a combination of plastic, sheet metal, aluminum, steel, other metal and/or composite materials depending on the desired weight and function of the structure including any desired protective or insulative properties.

Tank(s) 90 are contemplated for the storage of compressed air. In the alternative, one tank 90 may be incorporated into service unit 10. Tank(s) 90 is to be connected to an air compressor located on framework 20 or in housing 60. Tank(s) 90 receive and hold compressed air generated by the air compressor. Tank(s) 90 may also include one or more couplings for connection to one or more power tools or to one or more of the other service equipment devices.

As shown in FIGS. 2 and 4, tank(s) 90 may be disposed adjacent a support member 21 or between two support members 21. By design, the available space adjacent or between support members 21 of framework 20 may accommodate tank(s) 90 having a volume capacity from about five gallons to about fifteen gallons. By design and integration, tank(s) 90 may serve as a structural support member of framework 20 adding rigidity and support capacity to framework 20. For example, cross-members 24 or other suitable blocking may be also connected to tank(s) 90 thereby providing additional support of other overlying service units components or devices. In addition, the integration of tank(s) 90 with member 21 distributes the moment force resulting from the placing and loading of crane 30 on mounting deck 27 across tank(s) 90 as well.

In one embodiment the length L of service unit 10 when disposed on structural frame 6 of a service vehicle extends laterally to a distance substantially coextensive with the distance between the sides of adjacent service bed 9 or other service equipment on the frame or service bed 9 of the service vehicle, thereby providing that the overall length of service unit 10 with its attached service equipment devices may be confined to the overall width of the service vehicle, that is, the length of service unit 10 may be selected to remain no wider than the service vehicle independent of service unit 10. The shorter width W or depth of service unit 10 may extend a distance rearward of cab 7 of the service vehicle along the length of the structure frame 6 of the service vehicle. As a result, in plan view, the horizontal area footprint of service unit 10 may be substantially rectangular. Having a substantially rectangular area footprint, service unit 10 may be advantageously confined to a narrow corridor across the back of the service vehicle leaving greater area rearward of the cab to be occupied by a service bed. The width of service unit 10 may be confined from about twelve inches to about thirty-six inches.

The service unit 10 may be placed adjacent cab 7 of the service vehicle in a space rearward of cab 7 along a length of the structural frame 6 of the service vehicle which is not occupied by a bed of the service vehicle as shown in FIG. 1. In this configuration, service unit 10 may position crane 30 on mounting deck 27 and enclosure 80 substantially opposite each other in relation to the structural frame 6 of the service vehicle in a straddle or saddle-bag type relationship as depicted in FIG. 1.

In one embodiment, the width of service unit 10 occupies only about a twenty-four-inch space rearward of cab 7 of the service vehicle. When a two-foot width service unit 10 is placed along a length of the structural frame 6 of the service vehicle adjacent the rear of the cab in a space which is not occupied by a service bed, service unit 10 advantageously permits installation of service beds scalable to the cab-to-axle space depending on the size and length of the structural frame 6 of the service vehicle rearward of the cab.

Because service equipment devices may be attached to service unit 10 independent of the frame or service bed of the service vehicle, service unit 10 provides manufacturing advantages over the prior service vehicle configurations. One advantage is that service unit 10 with its attendant service equipment devices may be manufactured and assembled without requiring the presence of the service vehicle; service unit 10 may be manufactured and assembled independent of the service vehicle frame, bed or body. Once assembled, service unit 10 may be attached to the structural frame 6 or service bed 9 of the service vehicle. As a result, substantial downtime of the service vehicle is avoided.

The service equipment devices attached to service unit 10 may be self-powered, independent of the engine or other electrical power system of the service vehicle and of any external power source unassociated with the service vehicle. For example, service equipment devices attached to service unit 10 may comprise a gas or diesel engine used to drive a generator for electrical power for a welder and/or for one or more electrical outlets on the welder, for one or more electrical outlets on housing 60 or elsewhere on service unit 10, or to drive electrically-driven outriggers 40. The welder may be contained in housing 60 or may be a briefcase type welder not contained in housing 60 but which is otherwise transported in or on the service vehicle. In the alternative, the gas or diesel engine may be used to drive a hydraulic system for the operation of hydraulic outriggers 40 and/or crane 30.

A service equipment device of service unit 10 may comprise an air compressor. The air compressor may be driven directly by the gas or diesel engine. In the alternative, when a service equipment device also comprises an electric motor, and when an electrical power source is available, the air compressor may be driven by the electric motor. The air compressor is connected to reservoir tank(s) 90 for storage of compressed air for use by any pneumatic service equipment or power tools.

In the alternative, if an external, auxiliary electrical power is available, service equipment devices of service unit 10 may comprise smaller, lighter electric motors such as DC brushless motors to power the air compressor or drive hydraulic systems.

The disclosed technology may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A service unit apparatus for installation on a service vehicle having a structural frame rearward of cab of the service vehicle, the structural frame having a top side, The apparatus comprising:
A support framework separate from the service vehicle and its frame, the support framework comprising one or more support members, the support members having a top support surface, the support framework defining a first end and a second end, the support framework for supporting one or more service equipment devices, the support framework comprising:
A first support surface comprising or supported by the top surface of at least one of the support members of the support framework;
A second support surface comprising a step-down support surface at one end of the support framework, the second support surface disposed vertically lower than the first support surface;
A housing disposed on the support framework;
One or more service equipment devices enclosed within the housing;
One or more outriggers attached to the support framework; and
A crane disposed on the step-down surface of the second support surface.

2. The apparatus of claim 1 wherein the support framework and housing are contained within a footprint width of about twenty-four inches.

3. The apparatus of claim 1 wherein one of the service equipment devices comprises a fuel combustion engine and the fuel combustion engine powers one or more of the other service equipment devices.

4. The apparatus of claim 1 wherein one of the service equipment devices is an electric motor and the electric motor powers one or more of the other service equipment devices.

5. The apparatus of claim 1 wherein one of the service equipment devices is an electric power unit and the electric power unit provides electrical power to one or more of the other service equipment devices.

6. The apparatus of claim 1 wherein one of the service equipment devices is air compressor.

7. The apparatus of claim 6 further comprising a tank for receiving and holding compressed air generated by the air compressor, the tank attached to the air compressor, the tank further comprising one or more couplings for connection to one or more power tools or to one or more of the other service equipment devices.

8. The apparatus of claim 7 wherein the tank is disposed adjacent or between one or more support members of the support framework.

9. The apparatus of claim 1 wherein the support framework is configured for attachment to the structural frame of the service vehicle rearward of the cab of the service vehicle.

10. A service unit apparatus for installation on a service vehicle having a structural frame rearward of cab of the service vehicle, the structural frame having a top side, The apparatus comprising:
A support framework separate from the service vehicle and its frame, the support framework comprising one or more support members, the support members having a top support surface, the support framework defining a first end and a second end, the support framework for supporting one or more service equipment devices, the support framework comprising:
A first support surface comprising or supported by the top surface of at least one of the support members of the support framework; and
A second support surface comprising a step-down support surface at one end of the support framework, the second support surface disposed vertically lower than the first support surface, the second support surface configured to support a crane.

11. The apparatus of claim 10 comprising a width from about twelve to about thirty-six inches.

12. The apparatus of claim 10 wherein the step-down support surface is disposed lower than the top side of the structural frame of the service vehicle when the support framework is connected to the structural frame of the service vehicle.

13. The apparatus of claim 12 wherein the step-down support surface is disposed from about four inches to about twenty-four inches lower than the top of the first support surface.

14. The apparatus of claim 10, the support framework further comprising a third support surface disposed vertically higher than vertical height of the first and second support surfaces.

15. The apparatus of claim 14 further comprising one or more service equipment devices supported on or by the first support surface and/or the third support surface.

16. The apparatus of claim 15 wherein the one or more service equipment comprises a fuel-powered engine, an electric motor, an electric power generator, a hydraulic pump, an air compressor, tanks to hold compressed air, batteries, a battery charger, a power unit and/or a reservoir of hydraulic fluid.

17. The apparatus of claim 16 further comprising a housing, the housing enclosing one or more service equipment devices.

18. The apparatus of claim 17 wherein the housing has a width of about twenty-four inches.

19. The apparatus of claim 10 further comprising one or more outriggers attached at or near the first end and/or at or near the second end of the support framework.

20. The apparatus of claim 10 further comprising a crane, the crane attached to the second support surface.
